(19) United States
(12) Patent Application Publication
(10) Pub. No.: US 2014/0184561 A1
(43) Pub. Date: Jul. 3, 2014

(54) TOUCH SENSOR IC, TOUCH SENSING APPARATUS, AND COORDINATE CORRECTING METHOD OF THE TOUCH SENSING APPARATUS

(71) Applicant: Melfas Inc., Seoul (KR)

(72) Inventor: Seob KIM, Seoul (KR)

(73) Assignee: Melfas Inc., Seoul (KR)

(21) Appl. No.: 14/134,967

(22) Filed: Dec. 19, 2013

(30) Foreign Application Priority Data
Dec. 31, 2012 (KR) 10-2012-0158576

(51) Int. Cl. G06F 3/044

(52) U.S. Cl. CPC G06F 3/044
USPC 345/174

(57) ABSTRACT

A touch sensing apparatus may include a sensing area including a plurality of sensing nodes; and a touch sensor integrated chip (IC) configured to acquire a sensing signal and an individual coordinate for each sensing node in response to a touch input occurring on the sensing area. The touch sensor IC may calculate a corrected coordinate corresponding to the touch input based on the sensing signal.

### CROSS-REFERENCE TO RELATED APPLICATION

This application claims the priority benefit of Korean Patent Application No. 10-2012-0158576, filed on Dec. 31, 2012, in the Korean Intellectual Property Office, the disclosure of which is incorporated herein by reference.

### BACKGROUND

1. Field of the Invention

The present invention relates to a touch sensor integrated chip (IC), a touch sensing apparatus, and a coordinate correcting method of the touch sensing apparatus.

2. Description of the Related Art

A touch sensing apparatus refers to an apparatus that senses a touch of a finger of a user or another instrument, converts the sensed touch to an appropriate electrical signal, and outputs the electrical signal. The touch sensing apparatus has been applied to a variety of electronic devices and may be employed as an input device. For example, the touch sensing apparatus may be applied to a laptop computer and be used as an input device to control a movement of a cursor in lieu of a mouse, or may be used as an input device to directly select an icon or a menu displayed on a screen and execute the selected icon or menu. Further, the touch sensing apparatus may be used as a device to replace a button. Currently, screens of electronic devices have been enlarged and devices have been miniaturized. With such a trend, an input device, such as a key pad, for example, may be excluded and a touch input device, for example, a touch screen coupled with a display may be more frequently used as a sole input device or at least a main input device.

The touch sensing apparatus may calculate a touch point and a touch sensitivity by verifying a change in a capacitance occurring in a sensing node when a plurality of sensing nodes is provided on a sensing area and a touch occurs on the touch sensing apparatus.

However, a sensing node adjacent in a predetermined direction is absent on an edge portion of the sensing area. Thus, when a touch input occurs on the edge portion of the sensing area, an accurate touch point may not be calculated.

### SUMMARY

An aspect of the present invention provides a touch sensing apparatus that may enhance a precision and accuracy of a touch input occurring on an edge portion of a sensing area without adding a physical configuration.

Another aspect of the present invention also provides a coordinate correcting method of a touch sensing apparatus that may enhance precision and accuracy of a touch input occurring on an edge portion of a sensing area.

Features of the present invention are not limited to the aforementioned technical features and other technical features not described herein will be clearly understood by those skilled in the art from the following description.

According to an aspect of the present invention, there is provided a touch sensing apparatus, including: a sensing area including a plurality of sensing nodes; and a touch sensor integrated chip (IC) configured to acquire a sensing signal and an individual coordinate for each sensing node in response to a touch input occurring on the sensing area. The touch sensor IC may be configured to calculate a corrected coordinate corresponding to the touch input based on the sensing signal.

According to another aspect of the present invention, there is provided a touch sensor IC, including: a signal acquirer configured to acquire a sensing signal for each sensing node in response to a touch input occurring on a sensing area of a touch sensing apparatus; a coordinate acquirer configured to acquire an individual coordinate for each sensing node in response to the touch input; and a corrected coordinate calculator configured to calculate a corrected coordinate corresponding to the touch input based on the sensing signal acquired by the signal acquirer.

According to still another aspect of the present invention, there is provided a coordinate correcting method of a touch sensing apparatus with a defined sensing area, the method including: acquiring a sensing signal for each sensing node in response to a touch input occurring on the sensing area; acquiring an individual coordinate of a sensing node at which the sensing signal is acquired; and calculating a corrected coordinate corresponding to the touch input based on the sensing signal.

Specific matters of embodiments are included in the detailed description and drawings.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure of a touch sensing apparatus according to an embodiment of the present invention;

FIG. 2 is a block diagram illustrating a configuration of a touch sensor IC of a touch sensing apparatus according to an embodiment of the present invention;

FIG. 3 is a cross-sectional view to describe an operation principle of the touch sensing apparatus of FIG. 1;

FIG. 4 is a diagram illustrating an operation of a touch sensor IC configured to correct a coordinate in response to a touch input occurring on a touch sensing apparatus according to an embodiment of the present invention;

FIG. 5 is a graph illustrating strength of a sensing signal acquired at a sensing node in response to the touch input of FIG. 4 having occurred on the touch sensing apparatus according to an embodiment of the present invention; and

FIG. 6 is a flowchart illustrating a coordinate correcting method of a touch sensing apparatus according to an embodiment of the present invention.

### DETAILED DESCRIPTION

Advantages and features of the present invention, and a method for achieving the same will become clear with reference to embodiments described in detail together with the accompanying drawings. However, the present invention is not limited to the embodiments and thus, may be implemented in a variety of forms. The embodiments are provided to complement the disclosure of the present invention and to inform those skilled in the art about the scope of the present invention and the scope of the invention is defined by the claims. Like reference numerals refer to like constituent elements throughout. Sizes and relative sizes of layers and areas in the drawings may be exaggerated for clarity of description.

An element or a layer being disposed “above” or “on” another element or another layer may also include a case in which still another element or still another element is disposed therebetween.

Even though the terms “first”, “second”, and the like are used to describe a variety of constituent elements, the constituent elements are not limited thereto. The terms are used to distinguish one constituent element from another constituent element. Accordingly, a first constituent element described in the following may refer to a second constituent element without departing from the technical spirit of the present invention.

Hereinafter, embodiments of the present invention are described with reference to the accompanying drawings.

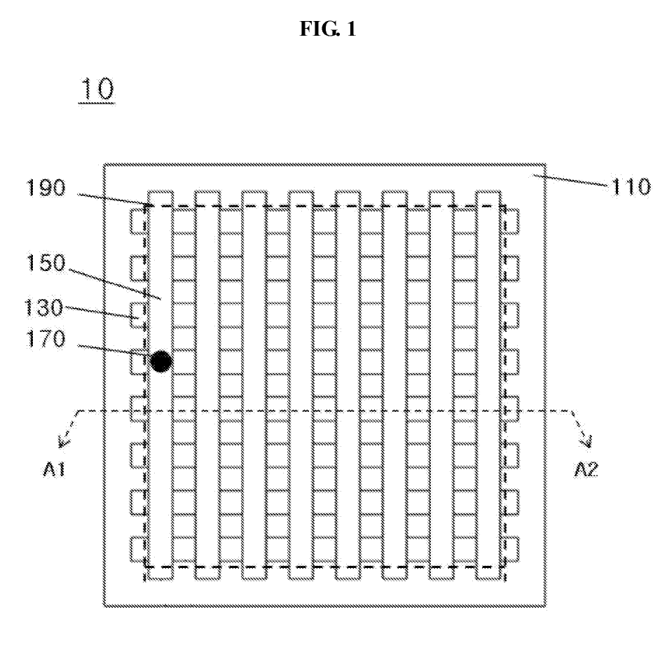

FIG. 1 is a diagram illustrating a structure of a touch sensing apparatus 10 according to an embodiment of the present invention.

Referring to FIG. 1, the touch sensing apparatus 10 may include an insulating substrate 110, a plurality of electrodes 130 and 150 formed on the insulating substrate 110, and a touch sensor integrated chip (IC) (not shown). A sensing area 190 may be defined on the touch sensing apparatus 10.

The insulating substrate 110 may be made of a transparent material. For example, a transparent plastic substrate, a substrate glass substrate, or a transparent quartz substrate may be used for the insulating substrate 110. A substrate may be a flexible substrate. For example, the insulating material 110 may be made of tempered glass or high hardened plastic that is a combination of at least one of plastic materials, such as poly methyl methacrylate (PMMA), polycarbonate (PC), and polyethylene terephthalate (PET), for example.

The plurality of electrodes 130 and 150 may be formed on the insulating substrate 110. The plurality of electrodes 130 and 150 may include a plurality of first electrodes 130 extended in a first axial direction, which is a horizontal direction in the drawings, and a plurality of second electrodes 150 extended in a second axial direction that intersects the first axial direction. Here, the second axial direction is a vertical direction in the drawings. A first axis and a second axis may meet at a right angle, but the present invention is not limited thereto.

The first electrode 130 and the second electrode 150 may be electrically separate from each other. Being electrically separate from each other may include a meaning of being physically separate from each other and thus, not being electrically connected to each other in a direct manner. For example, even though not illustrated, an insulating layer or a substrate having an insulating property may be disposed between the first electrode 130 and the second electrode 150.

The plurality of first electrodes 130 and the plurality of second electrodes 150 may be transparent electrodes. For example, the plurality of first electrodes 130 and the plurality of second electrodes 150 may include a transparent conductive material, such as, indium tin oxide (ITO), indium zinc oxide (IZO), and zinc oxide (ZO), for example, carbon nano tube (CNT), graphene, and/or silver nanowire, but the present invention is not limited thereto. The plurality of first electrodes 130 and the plurality of second electrodes 150 may be made of the same material, and may also be made of different materials.

The plurality of first electrodes 130 may be a driving channel configured to apply a driving signal. The plurality of second electrodes 150 may be a sensing channel configured to detect a change in mutual capacitance by a touch input.

A sensing node 170 may be defined on a portion in which the first electrode 130 and the second electrode 150 intersect. An area in which the sensing node 170 is defined may refer to the sensing area 190 capable of receiving a touch input from a user. Each sensing node 170 may have a coordinate value. For example, the sensing node 170 may have a matrix alignment corresponding to an orthogonal coordinate system and may have a coordinate value corresponding thereto.

A touch sensor IC (not shown) may acquire a sensing signal for each sensing node 170 and may calculate a touch location based on a change in mutual capacitance occurring between the plurality of first electrodes 130 and the plurality of second electrodes 150 due to a touch input on the sensing area 190.

The touch sensor IC may be mounted on a flexible printed circuit board (FPCB) or may be mounted on the insulating substrate 110 in a chip-on-glass (COG) form or a chip-on-board (COB) form, and thereby be electrically connected to at least one of the plurality of first electrodes 130 and the plurality of second electrodes 150.

Even though not illustrated, the touch sensing apparatus 10 may further include a wiring pattern configured to electrically connect the plurality of first electrodes 130, the plurality of second electrodes 150, and the touch sensor IC.

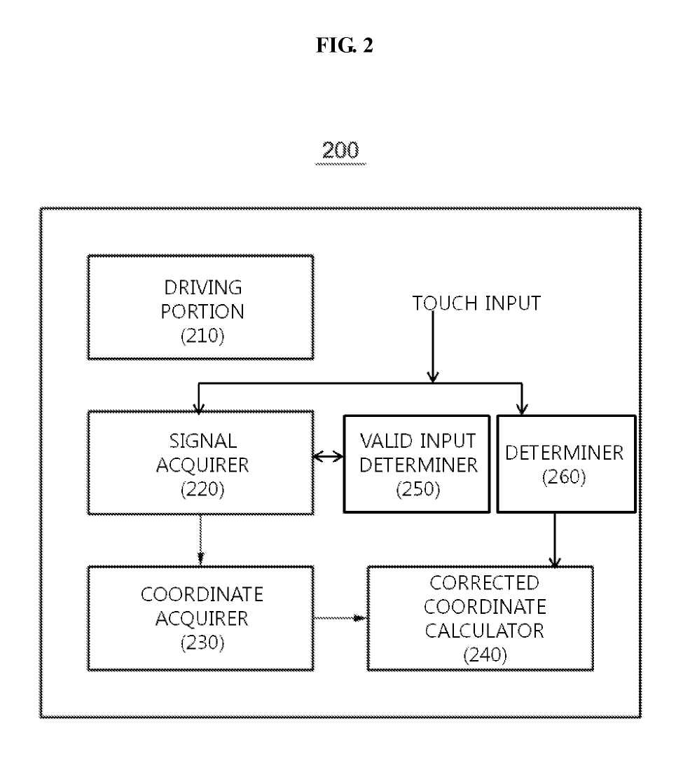

FIG. 2 is a block diagram illustrating a configuration of a touch sensor IC 200 of a touch sensing apparatus according to an embodiment of the present invention.

Referring to FIG. 2, the touch sensor IC 200 may include a driving portion 210 configured to drive a driving signal to an electrode to be driven, a signal acquirer 220 configured to acquire a sensing signal for each sensing node in response to a touch input occurring on a sensing area of the touch sensing apparatus 10, a coordinate acquirer 230 configured to acquire an individual coordinate of a sensing node at which the sensing signal is acquired, and a corrected coordinate calculator 240 configured to calculate a corrected coordinate corresponding to the touch input based on the sensing signal acquired by the signal acquirer 220.

The touch sensor IC 200 may further include a valid input determiner 250 configured to determine only an acquired sensing signal greater than or equal to a threshold to be a valid touch input. In this example, the corrected coordinate calculator 240 may calculate a corrected coordinate only when the valid input determiner determines that the touch input is a valid touch input.

Further, the touch sensor IC 200 may further include a determiner 260 configured to determine whether the touch input has occurred on an edge portion of the sensing area. In this example, the corrected coordinate calculator 240 may calculate a corrected coordinate only when the determiner determines that the touch input has occurred on the edge portion of the sensing area.

The corrected coordinate calculator 240 may correct a touch location based on a value stored in a predetermined table. Due to electrical resistance, an error may occur when determining a touch location. An error that may occur during a touch location calculating process may be corrected by storing a value capable of correcting a resistance component in a lookup table and if necessary, calculating a touch location based on the stored value. Also, the corrected coordinate calculator 240 may enhance an accuracy of touch location determination by maintaining, in the lookup table, a value used to correct not a resistance component but a coordinate, and correcting the a coordinate based on the stored value.

The corrected coordinate calculator 240 may enhance an accuracy of touch location determination by correcting the touch input having occurred on the edge portion of the sensing area, for example, the sensing area 190 of FIG. 1. The touch sensor IC 200 is described in more detail.

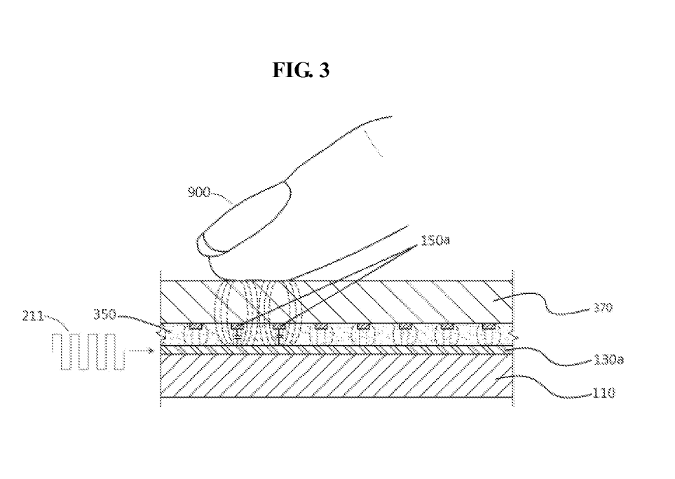

FIG. 3 is a cross-sectional view to describe an operation principle of the touch sensing apparatus 10 of FIG. 1, and illustrates an example of a cross section taken along line A1-A2 of FIG. 1. Even though an example of the touch sensing apparatus 10 provided in a double-layer structure is described hereinafter, it is only an example and thus, the touch sensing apparatus 10 may be provided in a single-layer structure through design modification.

Referring to FIG. 3, when the touch sensing apparatus 10 is provided in the double-layer structure, a first electrode 130a to which a driving signal 211 is applied and a second electrode 150a configured to acquire a sensing signal from a touch sensor IC, for example, the touch sensor IC 200 of FIG. 2 may be formed on different layers. An insulating layer 350 may be disposed between the first electrode 130a and the second electrode 150a. A touch input may occur due to a touch object 900 on a transparent glass 370 of which one surface is externally exposed.

The touch sensor IC 200, for example, the driving portion 210 of the touch sensor IC 200 may apply the driving signal 211 to the first electrode 130a. With respect to a form of the driving signal 211, the driving signal 211 applied to the first electrode 130a is provided in a square wave form, but it is only an example. The form of the driving signal 211 is not limited thereto. For example, the driving signal 211 may be provided in a variety of forms, such as a sine wave form and a triangle wave form, for example.

Due to the touch object 900, a change in mutual capacitance may occur between the first electrode 130a to which the driving signal 211 is applied and the second electrode 150 adjacent thereto. The change in mutual capacitance may be detected by measuring a change in voltage between the first electrode 130a to which the driving signal 211 is applied and the second electrode 150a adjacent thereto. The touch sensor IC 200 may acquire a sensing signal for each sensing node based on the change in mutual capacitance, which may be performed by the signal acquirer 220 of the touch sensor IC 200. Also, the touch sensor IC 200 may acquire an individual coordinate of a sensing node at which a sensing signal is acquired, which may be performed by the coordinate acquirer 230 of the touch sensor IC 200.

The insulating layer 350 may be disposed between the first electrode 130 of FIG. 1 and the second electrode 150 of FIG. 1. The insulating layer 350 may be made of a transparent dielectric substance, such as plastic and glass, for example, a transparent adhesive component, and any other material known to those skilled in the art.

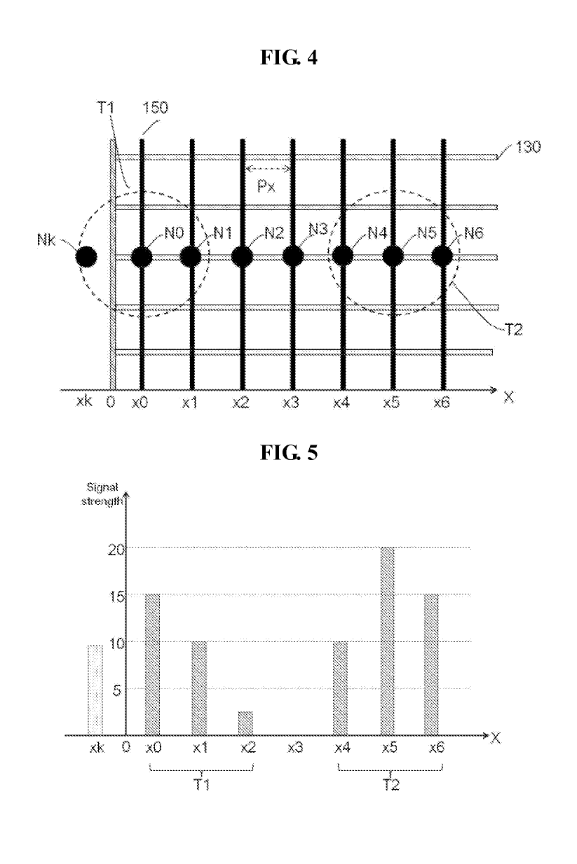

FIG. 4 is a diagram illustrating an operation of a touch sensor IC configured to correct a coordinate in response to a touch input occurring on a touch sensing apparatus according to an embodiment of the present invention.

Referring to FIG. 4, in response to a touch input, the touch sensing apparatus 10 may acquire a change in mutual capacitance occurring between a plurality of first electrodes 130 and a plurality of second electrodes 150, for example, strength of a sensing signal generated at a sensing node.

In detail, when a first touch input T1 and a second touch input T2 occur on the touch sensing apparatus 10, the touch sensor IC 200 of FIG. 2 may acquire, as a sensing signal for each sensing node, a change in mutual capacitance occurring between the first electrode 130 and the second electrode 150 in response to each of the first touch input T1 and the second touch input T2. For example, sensing signals may be acquired at an edge sensing node N0 that is disposed at a location nearest to an edge portion of a sensing area on which a touch input has occurred, and sensing nodes N1, N2, N3, N4, N5, and N6 (hereinafter, also referred to as reference sensing nodes) disposed on the same x axis as the edge sensing node N0. The reference sensing nodes N1, N2, N3, N4, N5, and N6 may refer to sensing nodes disposed in a direction perpendicular from the edge portion of the sensing area on which the touch input has occurred, based on the edge sensing node N0, for example, sensing nodes disposed in the same row as the edge sensing node N0.

An area disposed on the right side based on the edge sensing node N0 may correspond to the sensing area 190 of FIG. 1.

FIG. 5 is a graph illustrating strength of a sensing signal acquired at a sensing node in response to the touch input of FIG. 4 having occurred on the touch sensing apparatus 10 according to an embodiment of the present invention.

Referring to FIGS. 4 and 5, strength S of a sensing signal acquired at the edge sensing node N0 corresponding to x0 coordinate in response to each of the first touch input T1 and the second touch input T2 may be expressed as S(x0)=15. Similarly, strengths of sensing signals acquired at the respective sensing nodes N1, N2, N3, N4, N5, and N6 may be expressed as S(x1)=10, S(x2)=3, S(x3)=0, S(x4)=10, S(x5)=20, and S(x6)=15, respectively.

Hereinafter, an operation of a touch sensor IC 200 configured to calculate a corrected coordinate in response to each touch input, for example, the first touch input T1 and the second touch input T2 is described.

According to an embodiment, when a plurality of touch inputs, for example, the first touch input T1 and the second touch input T2, occurs on the touch sensing apparatus 10, the signal acquirer 220 of the touch sensor IC 200 of FIG. 2 may acquire a sensing signal for each sensing node, for example, N0, N1, and N2 in response to the first touch input T1 having occurred on the edge portion of the sensing area. For example, in response to the first touch input T1, the signal acquirer 220 may acquire sensing signals that are expressed as S(x0)=15, S(x1)=10, and S(x2)=3, respectively. When a sensing signal is acquired at the edge sensing node N0 in response to the first touch input T1, the first touch input T1 may be determined to be a touch input having occurred on the edge portion of the sensing area.

When a threshold is set, the determiner of the touch sensor IC 200 of FIG. 2 may determine only a sensing signal greater than or equal the threshold to be a sensing signal having been acquired in response to a valid touch input. The threshold may be a minimum marginal value of a sensing signal set not to determine noise as a touch input. For example, when the threshold is set as “5”, a value of S(x2) is less than “5” and thus, the determiner may determine a sensing signal sensed at a node x2 corresponding to the x2 coordinate to be an invalid signal.

Also, when a threshold is set, the determiner may also determine, as a single touch input, a section in which a sensing signal greater than or equal to the threshold is initially acquired and a sensing signal less than the threshold is initially acquired. For example, when the threshold is set as “5”, a sensing signal greater than or equal to the threshold is initially acquired at S(x0) and a sensing signal less than the threshold is initially acquired at S(x2). Accordingly, S(x0), S(x1), and S(x2) may be determined to be sensing signals having been generated in response to a single touch input, for example, the first touch input T1.

In addition to acquiring a sensing signal, the coordinate acquirer of the touch sensor IC 200 of FIG. 2 may acquire an individual coordinate of each sensing node, for example, N0, N1, and N2, at which a sensing signal is acquired in response to the first touch input T1 having occurred on the edge portion of the sensing area. When the aforementioned threshold is set, an individual coordinate of the sensing node N2 having a sensing signal less than the threshold may not be acquired depending on necessity. Hereinafter, an example in which a threshold is set and a sensing signal less than the threshold is not used as a variable to calculate a corrected coordinate is described, but it is only an example. For example, individual coordinates (x0, y) and (x1, y) may be acquired with respect to the sensing nodes N0 and N1 at which sensing signals greater than or equal to the threshold are acquired, and an individual coordinate may not be acquired with respect to the sensing node N2 at which a sensing signal less than the threshold is acquired. Depending on necessity, even though the sensing signal is less than the threshold, coordinate (x2, y) may be further acquired in addition to (x0, y) and (x1, y) in response to the first touch input T1 having occurred on the edge portion of the sensing area.

To calculate a more accurate touch location, the corrected coordinate calculator 240 of the touch sensor IC 200 of FIG. 2 may calculate a corrected coordinate of the first touch input T1. In detail, the corrected coordinate calculator 240 may generate a virtual sensing signal of a corresponding virtual sensing node Nk as a correction signal and thereby calculate a corrected coordinate, based on the assumption that the virtual sensing node Nk having xk as an x coordinate. Here, a distance between xk and x0 may be identical to a pitch Px of the second electrode 150. That is, the distance may be “x0−xk=Px” or “xo−xk=x1−x0”. For example, when a value of x0 has half of the pitch Px, xk may be −x0.

The virtual sensing signal may be generated by using, as a variable, the strength of a sensing signal acquired at the edge sensing node N0 in response to a single first touch input T1.

For example, as expressed by Equation 1, S(x0) that is the sensing signal acquired at the edge sensing node N0 in response to the first touch input T1 may be multiplied by a predetermined constant “a” and a multiplication result may be assigned as S(xk) that is the strength of the virtual sensing signal of the virtual sensing node Nk.

S(xk)=a*S(x0) [Equation 1]

Here, the constant “a” may differ based on a size of an edge area excluding the sensing area on the touch sensing apparatus, strength of a sensing signal acquired at the edge sensing node N0, and/or any other variables known to those skilled in the art, and may have a value greater than “0” and less than “2”. However, the present invention is not limited thereto.

Alternatively, the virtual sensing signal may be generated by using, as a variable, a sum of sensing signals generated in response to the first touch input T1 and the sensing signal acquired at the edge sensing node N0, as expressed by Equation 2.

$$S ( xk ) = β \times \frac{S ( x 0 )}{{\sum }_{n = x 0}^{x 1} S ( n )} \qquad [ Equation 2 ]$$

Here, x1 may denote a coordinate value of a reference sensing node having acquired a sensing signal in response to the first touch input. Also, β may differ based on density of electrodes, a size of an edge area of the touch sensing apparatus, for example, an area excluding the sensing area, and strength of the sensing signal acquired at the edge sensing node N0, and may be generated based on a variable interacting with the strength of the sensing signal acquired at the edge sensing node N0.

β=γ*S(x0) [Equation 3]

In Equation 3, a constant “γ” may differ based on density of electrodes, a size of an edge area of the touch sensing apparatus, for example, an area excluding the sensing area, and strength of the sensing signal acquired at the edge sensing node N0, and may have a value greater than “0” and less than “2”. However, the present invention is not limited thereto.

Hereinafter, a description will be made based on a case in which γ has a value of “1”.

For example, among sensing signals, expressed as S(x0)=15, S(x1)=10, and S(x2)=3, acquired at the respective sensing nodes in response to the first touch input T1, a sum of strengths of valid sensing signals greater than or equal to a threshold, that is, S(x0)+S(x1)=25 may be calculated. A ratio of the edge sensing node N0 to the sum of sensing signals, that is, S(x0)/25=0.6 may be calculated. By multiplying the calculated ratio by a strength value of the sensing signal of the edge sensing node N0, S(x0)*0.6=9 may be calculated. The calculation result may be assigned as S(xk) that is the strength of the virtual sensing signal strength of the virtual sensing node Nk.

Presuming that the virtual sensing node Nk having an xk coordinate has the aforementioned virtual sensing signal strength, a corrected coordinate of the first touch input T1 may be calculated.

For example, the corrected coordinate may be calculated by using, as a weight of each x coordinate, strength of a sensing signal that is acquired for each sensing node. For example, the corrected coordinate of the first touch input T1 may be calculated based on {x0*S(xo)+x1*S(x1)+xk*S(xk)}/{S(xo)+S(x1)+S(xk)}.

When calculating a touch location based on only actual individual coordinates without calculating a corrected coordinate, the touch location of the first touch input T1 may be calculated based on {x0*S(xo)+x1*S(x1)}/{S(xo)+S(x1)}.

Meanwhile, when determining the touch location by calculating the corrected coordinate, the corrected coordinate may be calculated based on {x0*S(xo)+x1*S(x1)+xk*S(xk)}/{S(xo)+S(x1)+S(xk)}.

Referring to FIG. 5, xk has a negative value based on the drawing and thus, when determining a touch location by calculating a corrected coordinate, the touch location may be shifted toward the edge portion of the sensing area as compared to a case in which the corrected coordinate is not calculated. Accordingly, the touch sensing apparatus 10 may recognize the touch location as a location proximate to a location at which an actual touch input has occurred.

According to an embodiment of the present invention, calculating of the corrected coordinate may be performed only when the strength of a sensing signal greater than or equal to a threshold is acquired at the edge sensing node N0. However, the present invention is not limited thereto. When a sensing signal determined to be a valid touch input is sensed at only the edge sensing node N0, the valid input determiner of the touch sensing chip 200 may also determine strength of a sensing signal less than the threshold to be a valid sensing signal.

Meanwhile, only a case in which the first touch input T1 has occurred on a left edge portion of the sensing area is illustrated, but it is only an example. Thus, a touch input may occur on a right edge portion, an upper edge portion, or a lower edge portion of the sensing area. In this example, a coordinate of the virtual sensing node (Nk) may be modified and the virtual sensing signal may be calculated based on strength of a sensing signal acquired at a sensing node disposed at a location nearest to the right edge portion, the upper edge portion, or the lower edge portion.

According to another embodiment, after acquiring a sensing signal greater than or equal to a threshold or an individual coordinate for each sensing node, the determiner of the touch sensor IC 200 of FIG. 2 may determine whether to generate a corrected coordinate by determining which of the first touch input T1 and the second touch input T2 corresponds to a touch input having occurred on the edge portion of the sensing area.

In a determination of the touch input having occurred on the edge portion of the sensing area, when a sensing signal is acquired at the edge sensing node N0 as described above, the determiner may determine the first touch input T1 associated with the sensing signal of the edge sensing node N0 to be the touch input having occurred on the edge portion of the sensing area. Alternatively, the determiner may compare an individual coordinate acquired for each sensing node in response to the touch input to a coordinate of the edge portion of the sensing area and thereby determine whether they match. Through the above procedure, the determiner may determine whether the touch input has occurred on the edge portion of the sensing area. When the first touch input T1 is determined to be the touch input having occurred on the edge portion of the sensing area and the second touch input T2 is determined not to be the touch input having occurred on the edge portion of the sensing area, the corrected coordinate calculator may calculate a corrected coordinate of only the first touch input T1.

According to embodiments of the present invention, it is possible to enhance an accuracy and precision of a touch input at an edge portion of a sensing area without adding a separate physical electrode. Also, there is no need to modify a design in a structural aspect and thus, the present invention may be applicable to a touch sensing apparatus according to the related art. Accordingly, since a change in a design of the touch sensing apparatus is not required, it is possible to achieve a reduction in manufacturing costs.

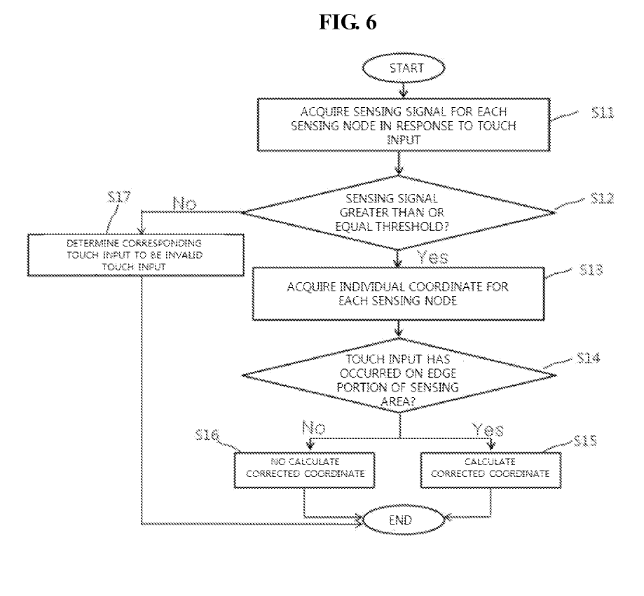

FIG. 6 is a flowchart illustrating a coordinate correcting method of a touch sensing apparatus according to an embodiment of the present invention.

Referring to FIG. 6, the coordinate correcting method of the touch sensing apparatus may include acquiring a sensing signal for each sensing node in response to a touch input occurring on the sensing area (S11), acquiring an individual coordinate of a sensing node at which the sensing signal is acquired (S13), and calculating a corrected coordinate corresponding to the touch input based on the sensing signal (S15).

The coordinate correcting method may further include determining whether a sensing signal is greater than or equal to a threshold after acquiring the sensing signal (S12). The coordinate correcting method may further include acquiring an individual coordinate for each sensing node only with respect to a sensing signal greater than or equal to the threshold (S13) and determining a touch input corresponding to a sensing signal less than the threshold be an invalid touch inputs (S17).

In addition, the coordinate correcting method may further include determining whether the touch input has occurred on the edge portion of the sensing area after acquiring an individual coordinate (S14). When the touch input is determined to have occurred on the edge portion of the sensing area, the coordinate correcting method may calculate a corrected coordinate based on the acquired sensing signal (S15). Conversely, when the touch input is determined to have not occurred on the edge portion of the sensing area, the coordinate correcting method may not calculate the corrected coordinate (S16).

A determination of whether the touch input has occurred on the edge portion of the sensing area may be performed as follows. For example, when a sensing signal is acquired at an edge sensing node disposed at a location nearest to the edge portion of the sensing area, a touch input, for example, the first touch input T1, associated with the sensing signal of the edge sensing node may be determined to be a touch input having occurred on the edge portion of the sensing area. Alternatively, whether the touch input has occurred on the edge portion of the sensing area may be determined by comparing an individual coordinate acquired for each sensing node in response to the touch input to a coordinate of the edge portion of the sensing area and thereby determining whether they match.

Operation S15 of calculating a corrected coordinate may be performed as follows. For example, a virtual sensing signal may be calculated based on the acquired sensing signal, and a corrected coordinate may be calculated by performing an operation based on the sensing signal, the virtual sensing signal, and the individual coordinate.

As described above with reference to FIGS. 4 and 5, the virtual sensing signal is a sensing signal assigned to a virtual sensing node having a predetermined coordinate. Also, the virtual sensing signal may be calculated based on the sensing signal acquired at the edge sensing node. A sum of a sensing signal acquired at a reference sensing node and the sensing signal acquired at the edge sensing node may be further used as a variable. Here, a sensing signal less than a threshold may not be used as a variable, which is described above with reference to FIGS. 4 and 5.

According to embodiments of the present invention, the following effects may be achieved.

Without adding a physical configuration or changing a design, it is possible to enhance an input accuracy of a touch sensing apparatus. In particular, it is possible to more accurately sense a location of a touch input occurring on an edge portion of the touch sensing apparatus.

The effects of the present invention are not limited to the above examples and thus, a variety of effects are included in the present specification.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A touch sensing apparatus, comprising:
a sensing area comprising a plurality of sensing nodes; and
a touch sensor integrated chip (IC) configured to acquire a sensing signal and an individual coordinate for each sensing node in response to a touch input occurring on the sensing area,
wherein the touch sensor IC is configured to calculate a corrected coordinate corresponding to the touch input based on the sensing signal.

2. The touch sensing apparatus of claim 1, wherein the touch sensor IC is configured to
calculate a virtual sensing signal based on the sensing signal, and
calculate the corrected coordinate based on the sensing signal, the individual coordinate, and the virtual sensing signal.

3. The touch sensing apparatus of claim 2, wherein the touch sensor IC is configured to calculate the corrected coordinate in response to the touch input occurring on an edge portion of the sensing area.

4. The touch sensing apparatus of claim 3, wherein the touch sensor IC is configured to calculate the corrected coordinate when a sensing signal acquired at an edge sensing node disposed at a location nearest to the edge portion of the sensing area is greater than or equal to a threshold.

5. The touch sensing apparatus of claim 2, wherein the touch sensor IC is configured to calculate the virtual sensing signal based on a sensing signal acquired at an edge sensing node disposed at a location nearest to an edge portion of the sensing area.

6. The touch sensing apparatus of claim 5, wherein the touch sensor IC is configured to calculate the virtual sensing signal based on a sum of sensing signals acquired at respective reference sensing nodes disposed on a same row as the edge sensing node in response to the touch input occurring on the edge portion of the sensing area and the sensing signal acquired at the edge sensing node.

7. The touch sensing apparatus of claim 6, wherein the touch sensor IC is configured to calculate the corrected coordinate based on a sum of sensing signals greater than or equal to a threshold among the sensing signals acquired at the respective reference sensing nodes and the sensing signal acquired at the edge sensing node.

8. The touch sensing apparatus of claim 1, wherein the touch sensor IC is configured to acquire an individual coordinate of a sensing node at which a sensing signal greater than a threshold is acquired.

9. The touch sensing apparatus of claim 1, further comprising:
a first electrode extended in a first axial direction; and
a second electrode extended in a second axial direction that intersects the first axial direction,
wherein the sensing node is defined on a portion in which the first electrode and the second electrode intersect.

10. A touch sensor integrated chip (IC), comprising:
a signal acquirer configured to acquire a sensing signal for each sensing node in response to a touch input occurring on a sensing area of a touch sensing apparatus;
a coordinate acquirer configured to acquire an individual coordinate for each sensing node in response to the touch input; and
a corrected coordinate calculator configured to calculate a corrected coordinate corresponding to the touch input based on the sensing signal acquired by the signal acquirer.

11. The touch sensor IC of claim 10, further comprising:
a determiner configured to determine whether the touch input is an input occurring on an edge portion of the sensing area,
wherein the corrected coordinate calculator is configured to calculate the corrected coordinate when the touch input is determined to be an input occurring on the edge portion of the sensing area.

12. The touch sensor IC of claim 10, wherein the coordinate acquirer is configured to acquire an individual coordinate of a sensing node at which a sensing signal greater than or equal to a threshold is acquired.

13. The touch sensor IC of claim 10, wherein the corrected coordinate calculator is configured to
calculate a virtual sensing signal based on the sensing signal, and
calculate the corrected coordinate based on the sensing signal, the individual coordinate, and the virtual sensing signal.

14. The touch sensor IC of claim 13, wherein the corrected coordinate calculator is configured to calculate the virtual sensing signal based on a sensing signal acquired at an edge sensing node disposed at a location nearest to an edge portion of the sensing area.

15. The touch sensor IC of claim 14, wherein the corrected coordinate calculator is configured to calculate the virtual sensing signal based on a sum of sensing signals acquired at respective reference sensing nodes disposed on a same row as the edge sensing node and the sensing signal acquired at the edge sensing node.

16. The touch sensor IC of claim 15, wherein the corrected coordinate calculator is configured to calculate the virtual sensing signal based on a sum of sensing signals greater than or equal to a threshold among the sensing signals acquired at the respective reference sensing nodes and the sensing signal acquired at the edge sensing node.

17. A coordinate correcting method of a touch sensing apparatus with a defined sensing area, the method comprising:
acquiring a sensing signal for each sensing node in response to a touch input occurring on the sensing area;
acquiring an individual coordinate of a sensing node at which the sensing signal is acquired; and
calculating a corrected coordinate corresponding to the touch input based on the sensing signal.

18. The method of claim 17, wherein the calculating of the corrected coordinate comprises:
calculating a virtual sensing signal based on the acquired sensing signal; and
performing a calculation based on the sensing signal, the individual coordinate, and the virtual sensing signal.

19. The method of claim 18, wherein the virtual sensing signal is calculated based on a sensing signal acquired at an edge sensing node disposed at a location nearest to an edge portion of the sensing area.

20. The method of claim 19, wherein the virtual sensing signal is calculated based on a sum of sensing signals acquired at respective reference sensing nodes disposed in a same row as the edge sensing node and the sensing signal acquired at the edge sensing node.

21. The method of claim 20, wherein the virtual sensing signal is calculated based on a sum of sensing signals greater than or equal to a threshold among the sensing signals acquired at the respective reference sensing nodes and the sensing signal acquired at the edge sensing node.

22. The method of claim 17, further comprising:
determining a sensing signal greater than or equal to a threshold to be a valid touch input after acquiring the sensing signal,
wherein the acquiring of the individual coordinate is performed when the touch input is determined to be the valid touch input.

23. The method of claim 17, further comprising:
determining whether the touch input is an input occurring on an edge portion of the sensing area before calculating the corrected coordinate,
wherein the calculating of the corrected coordinate is performed when the touch input is determined to be the input occurring on the edge portion of the sensing area.
